(19) United States
(12) Patent Application Publication
(10) Pub. No.: US 2026/0024829 A1
(43) Pub. Date: Jan. 22, 2026

(54) SMART BATTERY WITH INTEGRATED INTERNAL THERMAL SENSOR

(71) Applicant: Nano and Advanced Materials Institute Limited, Hong Kong (HK)

(72) Inventors: Cheuk Yin LEE, Hong Kong (HK); Wing Lung HON, Hong Kong (HK); Kin Chung HUI, Hong Kong (HK); Shengbo LU, Hong Kong (HK)

(21) Appl. No.: 19/273,137

(22) Filed: Jul. 18, 2025

Related U.S. Application Data
(60) Provisional application No. 63/673,839, filed on Jul. 22, 2024.

(51) Int. Cl. H01M 10/48; G01K 1/10; H01M 10/42

(52) U.S. Cl. CPC H01M 10/486; G01K 1/10; H01M 10/4257; G01K 2213/00; H01M 2010/4271; H01M 2010/4278

(57) ABSTRACT

A rechargeable battery system is provided. The rechargeable battery system comprises: a battery cell having a laminated housing enclosing electrolyte and electrode stacks; a thermal sensing pad embedded within the battery cell, the thermal sensing pad comprising a plurality of temperature sensors disposed at different internal positions within the battery cell, each temperature sensor encapsulated in an electrolyte-resistant material; an integrated circuit board electrically coupled with the thermal sensing pad, the integrated circuit board configured to: (a) receive sensor signals from the temperature sensors; (b) convert the sensor signals into digital temperature data; and (c) transmit the digital temperature data to a battery management system. The battery management system is configured to analyze the digital temperature data to assess internal temperature conditions of the battery cell.

### CROSS-REFERENCE TO RELATED APPLICATIONS

This application claims priority to U.S. Provisional Utility Patent application No. 63/673,839 filed Jul. 22, 2024; the disclosure of which is incorporated by reference herein in its entirety.

### FIELD OF THE INVENTION

The invention relates to a smart battery with an internally integrated thermal sensor, a battery system, and a method of measuring internal heat generation at different positions of the battery.

### BACKGROUND

Rechargeable lithium-based batteries are widely used in applications ranging from portable electronics and electric vehicles to aerospace systems and grid-scale energy storage. These batteries offer high energy density, long cycle life, and efficient charge-discharge characteristics. However, they are also susceptible to safety risks arising from abnormal thermal conditions, particularly thermal runaway.

Thermal runaway is a failure mode characterized by a rapid and self-amplifying increase in internal temperature, often leading to venting, fire, or explosion. The initiation of thermal runaway typically originates from internal regions of a battery cell due to localized heat buildup, which may be triggered by overcharging, internal short circuits, mechanical damage, or degradation of internal components. A key contributor to this phenomenon is the breakdown of the solid electrolyte interphase (SEI) on the anode surface, which, under elevated temperature conditions can lead to exothermic reactions with the electrolyte, further increasing internal heat generation.

Conventional battery management systems (BMS) typically rely on external temperature sensors that are mounted on the surface of cells or modules. While these sensors can detect general heating trends, they are limited in their ability to detect localized temperature spikes deep within the battery cell. Because thermal runaway often initiates from the interior of the cell, such external measurements may result in delayed detection and inadequate response, thereby compromising the safety and reliability of the system.

Moreover, as lithium battery technologies evolve toward higher energy densities and compact form factors, the thermal management challenge becomes more acute. High internal temperatures can develop rapidly and may remain undetected until external surfaces are affected, at which point mitigation strategies such as current cutoff or thermal venting may be too late to prevent damage or propagation of failure to neighboring cells.

There is therefore a need for systems and methods capable of directly measuring the internal temperature of lithium batteries. Such capabilities would allow early detection of adverse thermal conditions, improve diagnostic precision, and enable more responsive safety mechanisms. Embedding temperature sensors within the interior of the battery cell, or integrating advanced sensor architectures that provide real-time feedback from internal hotspots, can significantly enhance the safety and performance of lithium battery systems in demanding environments. The present invention addresses this need.

### SUMMARY OF THE INVENTION

The proposed invention offers a comprehensive solution to measure the internal heat generation within a battery. The solution includes the design of an electrolyte-resistant thermal sensing pad, the integration of this pad into the battery structure, an integrated circuit board, and application software. The thermal sensing pad, which incorporates at least five temperature sensors, is designed for internal placement within the battery to detect temperature variations at different locations. The battery structure is modified to accommodate this additional thermal sensing pad. The integrated circuit board, located outside the battery and connected to the thermal sensing pad, is tasked with acquiring the sensor signal from the sensing pad, converting the sensing signal to digital data, and transmitting it via USB or Bluetooth. The application software, compatible with smartphones, communicates with the integrated circuit board via USB or Bluetooth to display and record the data. This invention has the potential to provide high-precision temperature data to the latest battery management systems.

In accordance with one aspect of the present invention, a rechargeable battery system is provided. The rechargeable battery system comprises: a battery cell having a laminated housing enclosing electrolyte and electrode stacks; a thermal sensing pad embedded within the battery cell, the thermal sensing pad comprising a plurality of temperature sensors disposed at different internal positions within the battery cell, each temperature sensor encapsulated in an electrolyte-resistant material; an integrated circuit board electrically coupled with the thermal sensing pad, the integrated circuit board configured to: (a) receive sensor signals from the temperature sensors; (b) convert the sensor signals into digital temperature data; and (c) transmit the digital temperature data to a battery management system. The battery management system is configured to analyze the digital temperature data to assess internal temperature conditions of the battery cell.

In accordance with one embodiment, the battery management system is further configured to perform corrective action in response to detecting a thermal condition indicative of thermal runaway or uneven temperatures in different parts of the battery cell.

In accordance with another embodiment, the thermal sensing pad has a thickness of less than 0.3 mm and is embedded in direct contact with a surface of the electrode stacks or in a middle layer of the electrode stacks.

In accordance with yet another embodiment, the temperature sensors comprise at least one of: a thin-film micro-thermocouple, a thin-film resistance thermometer (RTD), or a thermistor.

In accordance with yet another embodiment, the integrated circuit board is further configured to analyze trends in temperature data, including detecting temperature rise rates or localized hot spots.

In accordance with one embodiment, the thermal sensing pad includes at least five temperature sensors positioned respectively near a battery terminal, at a central region, and at a base portion of the battery cell.

In accordance with another embodiment, the battery system further comprises a communication interface selected from the group consisting of USB and Bluetooth for transmitting the temperature data from the integrated circuit board.

In accordance with another aspect of the present invention, a method of measuring internal temperature within a battery cell is provided. The method comprises: embedding a thermal sensing pad within the battery cell, the thermal sensing pad comprising a plurality of temperature sensors at respective positions within the cell; measuring temperature data from each of the plurality of temperature sensors during battery operation; transmitting the temperature data to an integrated circuit board; converting the temperature data into digital signals using the integrated circuit board; and communicating the digital signals to a battery management system for analysis.

In accordance with one embodiment, the method further comprises analyzing the temperature data to identify a thermal anomaly, and initiating a corrective action to prevent thermal runaway or uneven temperatures in different parts of the battery cell.

In accordance with another embodiment, the thermal sensing pad comprises at least five temperature sensors located at spatially distinct regions including a battery terminal, a central portion, and a base of the cell.

In accordance with yet another embodiment, the temperature sensors are selected to provide a thermal measurement accuracy within ±0.2° C. over a range of 20° C. to 50° C.

### BRIEF DESCRIPTION OF THE DRAWINGS

FIG. 1 is a cross-sectional view of an encapsulated thermal sensor pad illustrating sensor placement, electrolyte-resistant encapsulation, and structural layers.

FIG. 2 is a perspective view of a smart battery with internal sensor pad integrated, showing sensor locations relative to battery internal components.

FIG. 3 is a schematic overview of an integrated circuit detailing power, control, sensing, and communication circuits.

FIG. 4 is a flowchart depicting firmware operational logic, including data collection, calibration routines, and Bluetooth communication setup.

FIG. 5A-5B show flowcharts illustrating operational logic of user interface software for wired and wireless (Bluetooth) connections.

FIG. 6 is a plot showing internal multi-point temperature measurements at various battery positions during discharge.

FIG. 7 depicts measured internal temperatures over a period of time highlighting the different temperatures at different positions within the battery.

### DETAILED DESCRIPTION

### 1. Battery Overview

A typical rechargeable lithium-ion cell is configured to store energy in a layered microstructure. A positive electrode (cathode) layer is typically a lithium oxide including other metal components such a nickel, cobalt, and manganese. This oxide may be coated on a metal current collector such as a copper or aluminum current collector. An example of a lithium-based oxide for the cathode is LiNi_{0.8}Mn_{0.1}Co_{0.1}O₂ (NMC811) coated on an aluminum foil current-collector. However, it is understood that the invention is applicable to any battery, regardless of battery composition.

The negative electrode (anode) layer is typically a carbon material such as graphite, although other materials such as silicon and lithium may also be used. These materials may be coated or plated onto a current collector as with the cathode.

A separator may be positioned between the cathode and the anode which may be a porous polymeric material such as polypropylene or polyethylene, optionally include coatings including ceramic particles. Alternative separators such as ceramic separators may also be used.

A liquid or gel electrolyte may be used such as ethylene carbonate (EC), dimethyl carbonate (DMC), and other solvents or mixtures of solvents that include lithium salts saturates the electrodes and separator.

During operation, a solid-electrolyte interphase (SEI) forms on the anode. This is a thin layer that includes lithium oxides, LiF, organic materials and polymerized solvent species. The SEI is a protective film that is chemically stable, and allows lithium ions to pass through; it prevents further reaction between the electrolyte and the anode. The SEI keeps the battery safe and stable.

### 2. Overview of Thermal Runaway

Thermal runaway, including uneven temperature condition, in lithium-based battery cells is a serious issue that can shorten battery lifespan and lower capacity. Thermal runaway is a multi-stage process involving sequential thermal and electrochemical reactions. Each stage is characterized by a distinct temperature threshold and a corresponding set of degradation mechanisms that cumulatively escalate the internal temperature of the cell. The following description outlines the typical stages of thermal runaway, with representative temperature ranges for each transition:

### Stage 1: Onset of SEI Decomposition (≈70° C.-120° C.)

At moderate elevated temperatures, the solid electrolyte interphase (SEI) layer, which passivates the surface of the anode, begins to degrade. The SEI is composed of inorganic and organic species formed during the first charge cycle and is essential to stable lithium-ion transport. As the temperature increases beyond approximately 70° C., partial decomposition of organic SEI components initiates exothermic reactions. At this stage, no visible external effects may be observed, but internal heat accumulation begins. Decomposition accelerates with temperature, and by 120° C., significant breakdown of the SEI layer can occur, exposing the anode to direct reaction with the electrolyte.

### Stage 2: Exothermic Reaction Between Anode and Electrolyte (≈120° C.-180° C.)

Upon degradation of the SEI, the graphite anode—lithiated during normal operation-becomes reactive with the organic electrolyte. This interaction produces additional heat and gaseous byproducts, including hydrocarbons, CO₂, and hydrogen. These reactions are highly exothermic and contribute to a sharp rise in internal temperature. The battery's internal pressure may begin to rise due to gas accumulation. Safety vents, if present, may activate at this stage. However, in the absence of effective mitigation, the temperature continues to rise unchecked.

### Stage 3: Melting and Collapse of Separator (≈130° C.-200° C.)

The polymer separator, typically composed of polyethylene or polypropylene, begins to soften and shrink at around 130° C. and may fully melt by approximately 200° C. The separator's collapse removes the physical barrier between the anode and cathode, significantly increasing the risk of internal short circuits. A short circuit under these conditions introduces a low-resistance pathway for current flow, rapidly releasing stored electrical energy as heat, further escalating the reaction rate.

### Stage 4: Cathode Decomposition and Oxygen Release (≈200° C.-250° C.+)

At temperatures exceeding 200° C., the cathode material (typically a lithium metal oxide such as LiCoO₂, NMC, or NCA) begins to thermally decompose. This decomposition is accompanied by the release of lattice-bound oxygen from the metal oxide structure. The presence of free oxygen in the cell environment enables spontaneous combustion of flammable electrolyte components, even in the absence of external air. This marks the transition from internal heating to open flame conditions, often observed as fire, smoke, or explosion. Cell rupture is likely at this stage, and thermal propagation to adjacent cells is a significant risk.

### Stage 5: Full Thermal Runaway Propagation (>250° C.)

Beyond 250° C., thermal runaway becomes self-sustaining and uncontrollable without external intervention. The internal temperature may exceed 600° C. locally. Combustion of remaining electrolyte and separator materials, as well as degradation of other cell components, leads to complete destruction of the cell. The heat and flame produced may ignite adjacent cells or external materials, posing a serious hazard to system safety.

This stage-based description is illustrative and can vary depending on cell chemistry, form factor, state-of-charge, and design architecture. However, these thermally triggered events form a consistent sequence in most lithium-based battery technologies and highlight the importance of detecting and responding to early-stage thermal conditions, particularly those involving SEI degradation and electrolyte interaction.

Through of real-time monitoring of the battery temperature, the rate of temperature rise can be determined. This temperature rise rate can indicate an approach of a thermal runaway reaction. Therefore, measuring the internal temperature rise rate may provide an effective mechanism for early warning of thermal runaway. Therefore, timely intervention by battery the battery management system can initiate protective actions to prevent further temperature escalation. This is important in order to prevent the onset of the self-sustaining reaction stage that becomes difficult to stop once initiated. Early detection of abnormal temperature rise and prompt intervention, such as cooling or disconnecting the battery, can potentially prevent thermal runaway from occurring. Temperature studies of the internal temperatures of lithium batteries can additionally help with the evaluation of battery designs in order to prevent potential thermal runaway conditions.

### 3. Thermal Sensor Structure

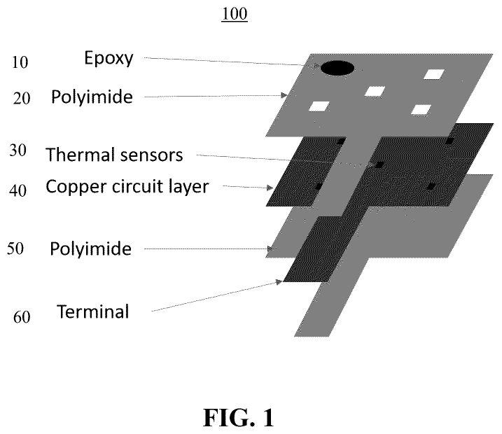

Referring now to FIG. 1, a thermal sensor pad structure 100 is provided for direct integration into a lithium battery cell. The thermal sensor pad is configured to measure localized internal temperatures at multiple strategic positions within the cell while withstanding prolonged exposure to liquid electrolyte environments. To this end, the sensor pad is encapsulated in an electrolyte-resistant material, such as an epoxy resin encapsulant 10, thereby preventing corrosion or degradation of the sensing elements and conductive layers.

The sensor pad structure includes a central copper circuit layer 40 on which a plurality of thermal sensors 30 are mounted. This copper layer serves as the conductive pathway for transmitting electrical signals from the thermal sensors to an external terminal interface 60. The copper circuit 40 is sandwiched between two polyimide insulating layers 20, 50, each serving a specific functional purpose. The bottom polyimide layer provides mechanical and chemical protection for the underside of the pad, while the top polyimide layer shields the copper circuitry and defines cut-out windows directly over the thermal sensor elements. These windows expose the sensor nodes during fabrication, permitting precise alignment and soldering to the underlying copper layer. Once soldered, each sensor is individually encapsulated in epoxy resin to create a robust barrier against electrolyte exposure. While polyimide is shown as an example, other materials such as polyimide (PI), polyether ether ketone (PEEK), polyethylene terephthalate (PET), epoxy resins, or any other electrolyte-resistant materials may also be used.

In the illustrated embodiment, the thermal sensor pad incorporates five individual thermal sensing points. This configuration enables multi-point thermal profiling of the battery during operation. One sensor is disposed proximate to the battery terminal, allowing for real-time monitoring of heat generation at the terminal contact point. A centrally located sensor is configured to assess the overall thermal condition of the cell by measuring temperature near the geometric center of the battery. Additionally, at least one sensor is positioned at the base of the battery cell, enabling early detection of heat buildup at the bottom edge—an area prone to thermal accumulation during certain charge/discharge cycles or under mechanical stress.

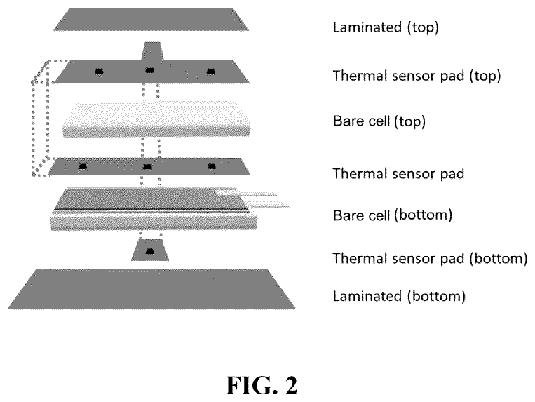

As shown in FIG. 2, the thermal sensor pads are integrated into a smart battery design. In one embodiment, the pads are installed in direct contact with the internal layers of the battery, with sensor terminals oriented toward the cell's center or bottom region, where localized heat generation is most likely to occur. This positioning allows the system to bypass thermal lag associated with external measurements, such as those taken through aluminum-laminated pouch layers, which possess low thermal conductivity and thus delay thermal response. In other embodiments, the thermal sensor pads and sensor terminals may be installed on different layers and at different positions depending on the size and configuration of the battery.

The thermal sensor pad is embedded within the laminated housing of the battery cell, along with the electrolyte and electrode stacks. To this end, the sensing pad is configured to have a sub-millimeter thickness; in particular, a thickness of approximately 0.3 mm or less. The sensor terminal ends protrude from the laminated structure and are configured to connect with an external integrated circuit board. The integrated circuit board receives real-time data from the embedded thermal sensors, enabling active temperature monitoring and protective response in the event of abnormal thermal behavior. During normal operation, the sensor pad remains chemically and electrically stable within the electrolyte environment, continuously measuring the battery's internal thermal dynamics without interfering with cell performance.

This configuration provides a granular and spatially resolved thermal map of the battery interior, facilitating early-stage detection of thermally hazardous conditions such as SEI breakdown, separator softening, localized shorting, or uneven temperatures in different parts of the battery. By incorporating electrolyte-resistant multi-point thermal sensors, the described system enhances both the diagnostic accuracy and safety resilience of high-energy-density lithium battery systems. As mentioned above, because of the potential hazard of uneven temperatures, the preferred embodiments are to employ more thermal sensors specifically placed in different layers and locations (sensing points) in the battery to better detect uneven temperatures and in turn the heat generation inside the battery.

Various temperature-measurement devices may be selected for each thermal sensing point 30. These include thin-film micro-thermocouples, thin-film resistance thermometers (RTDs), and thermistors. Thin-film micro-thermocouples generate a thermo-electric voltage proportional to the junction temperature. The sensor comprises two dissimilar metallic strips several microns. Thin-film resistance thermometers use the well-defined temperature coefficient of resistivity (TCR) of platinum or similar metals. Thermistors alter their resistance with temperature. Using different semiconductor materials and fabrication processes, thermistors can carry either a negative temperature coefficient (NTC) or a positive temperature coefficient (PTC). As the temperature increases, NTC thermistors decrease their resistance value, while PTC thermistors increase their resistance value. Other known thin thermal sensing devices may also be used. In particular, the overall combination of sensor is selected such that the thermal sensing pad has ±0.2° C. maximum error with the temperature range of 20 to 50° C.

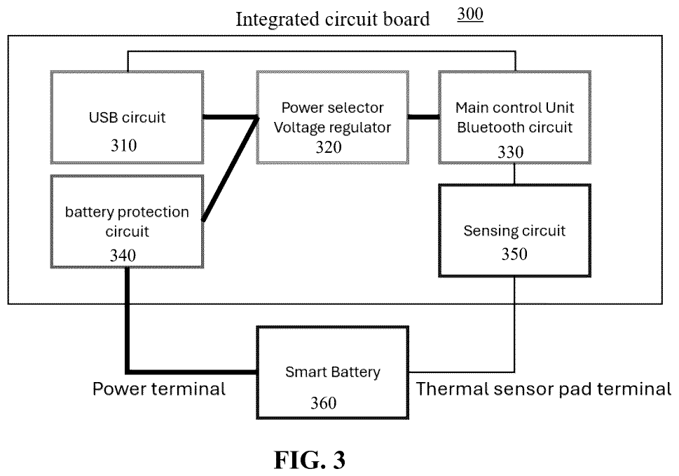

FIG. 3 is circuit diagram overview of an integrated circuit 300 used with the thermal sensing pad depicted in FIGS. 1-2. The integrated circuit communicates with the thermal sensors in order to determine the temperature at the various positions within the battery and issue periodic temperature readings, analyze temperature trends such as temperature rate increases that may indicate a prelude to thermal runaway or localized temperature spikes that may indicate a short circuit. Using this information, temperature studies of the internal behavior of batteries may be conducted. When temperature measurements indicate a potentially dangerous battery condition such as a short circuit or the beginning of thermal runaway, a battery protection circuit may be used to provide remediation of the condition by enabling cooling mechanisms or terminating battery charging/discharging.

Integrated circuit 300 includes a USB circuit 310, battery protection circuit 340, power selector and voltage regulator 320, main control unit and Bluetooth circuit 330, and sensing circuit 350. The USB circuit 310 provides computer connectivity and supplies power to the integrated circuit board. It includes a USB port for connecting the board to a computer. Additionally, it interfaces with the main control unit to convert data and commands between USB signals. The battery protection circuit 340 is configured for smart batteries, this circuit offers over-charging protection, over-discharge protection, overcurrent protection, and short circuit protection. The power selector and voltage regulator 320 connect to both the USB circuit and the battery protection circuit. The power selector prioritizes USB power if available; otherwise, it switches to battery power. The voltage regulator converts either USB voltage or battery voltage to a stable voltage, typically 3V, which powers the main control unit and Bluetooth circuit. The main control Unit and Bluetooth circuit 330 are responsible for managing the overall operation, the main control unit and Bluetooth circuit collect sensing data from the sensing circuit. They then convert this data into digital format and transmit it either via the USB circuit or wirelessly using Bluetooth protocol. The sensing circuit 350 establishes a connection to the thermal sensor pad. It measures the voltage corresponding to the temperature sensed by resistance temperature sensors on the thermal sensor pad.

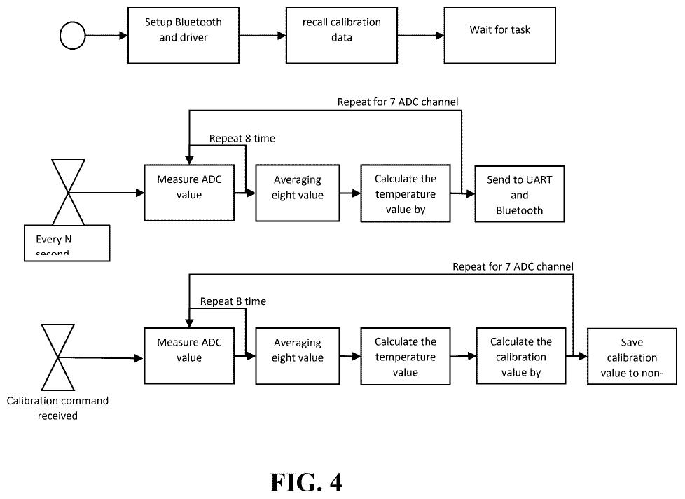

FIG. 4 illustrates a flowchart depicting the firmware for the main control unit and Bluetooth circuit 330 of FIG. 3. Upon powering up the integrated circuit board, the firmware configures the Bluetooth service by setting parameters such as advertising interval, minimum connection interval, maximum connection interval, connection timeout, and device name. Additionally, it initializes drivers used in the firmware, including UART, ADC, and NVS. Subsequently, it retrieves calibration data from its reserved memory and enters standby mode, awaiting task interruptions.

Two types of interruption tasks exist: periodic timer interruption and user command interruption. For periodic timer interruption, the firmware measures the temperature and sends it to both the UART and Bluetooth interfaces. When an interrupt occurs, the firmware wakes up and enters the measurement routine. This routine first measures the first channel eight times, averages those values, and then converts the averaged ADC value to a temperature reading. By combining this with the calibration data from memory, it calculates an accurate temperature value. This process is repeated for all channels, resulting in accurate temperature values. These values are sent to the UART interface for computer display (if available) and updated in the Bluetooth advertising data for display on Bluetooth devices.

Alternatively, when a user sends calibration data to the integrated circuit board via either UART or Bluetooth, the user command interruption is triggered. The firmware wakes up and enters the calibration routine. In this routine, the first channel is measured eight times, and the average ADC value is converted to a temperature reading. By comparing the measured average temperature value with the user-set temperature in the calibration command, the calibration data is calculated. This process is repeated for all channels, and the resulting calibration values are stored in non-volatile memory for subsequent temperature measurements.

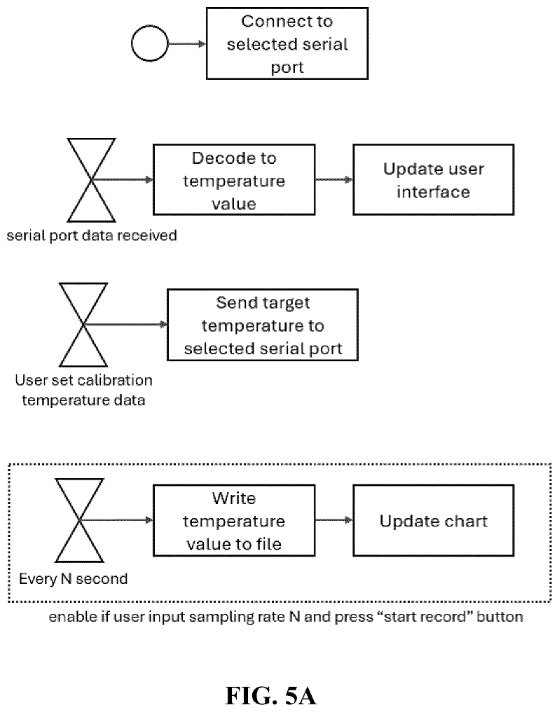

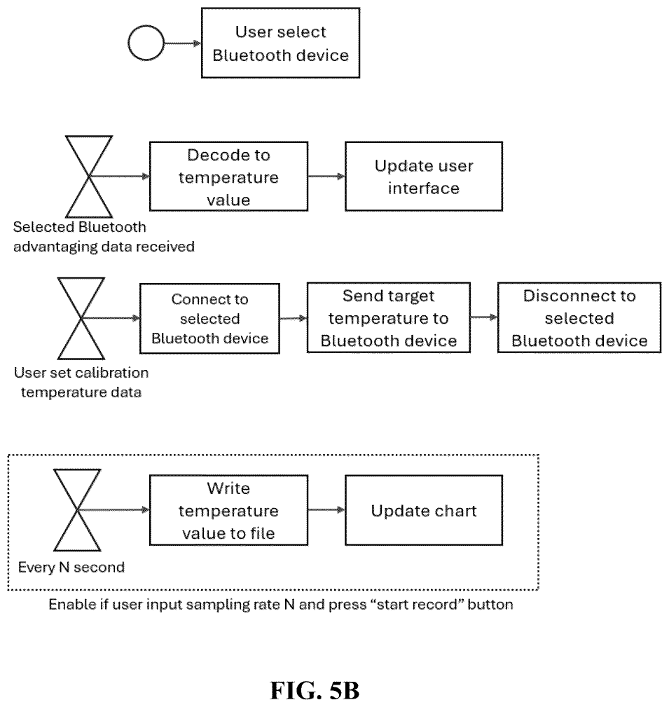

FIG. 5A is a sample flow chart of wire connected software. The operational flow begins with the software prompting the user to select the appropriate serial port connected to the temperature sensor. Once a connection is established, the software is designed to handle incoming data by triggering a ‘serial port data received event.’ This event initiates the reading and decoding of hexadecimal format data into a human-readable temperature value, which is then displayed on the user interface. Additionally, the software provides a feature for calibration where, upon pressing a designated button, a ‘set calibration temperature data event’ is triggered, sending the desired temperature settings to the sensor. Another key functionality is data recording; the user sets a sampling rate and starts the recording process through the interface. Subsequently, a timer event is activated, which captures temperature data at specified intervals, saving it to a file and updating a chart on the user interface for real-time monitoring.

FIG. 5B is a sample flow chat of Bluetooth connected application. When launching the app, it prompts the user to select a Bluetooth temperature sensor. Once a sensor is selected, the application listens for advertising data from the sensor. When such data is received, an event is triggered to read and decode the hexadecimal format data into a human-readable temperature format, which is then displayed on the user interface. If the user opts to calibrate the temperature data, they can press a dedicated button to raise an event that connects to the sensor, sets the desired target temperature, and then disconnects. Additionally, the user can set a sampling rate and initiate a recording session by pressing the ‘start record’ button. This action triggers a timer event that records the temperature data at specified intervals into a file and updates a chart on the user interface, providing a visual representation of the temperature changes over time.

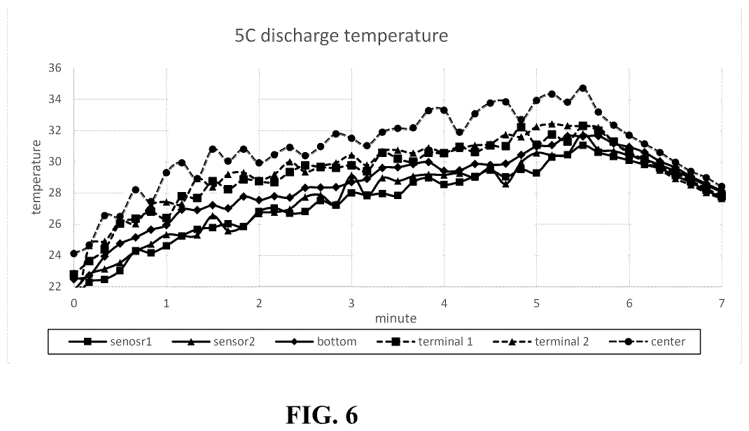

FIG. 6 is an example of an internal temperature data record of a smart battery 360 with integrated internal thermal sensor of FIGS. 1/2. The plot represents the internal temperature data of a 1000 mAh battery discharging at 5 C, with the temperature sensor being calibrated. The plot features six curves, each representing a different position within the battery. The dot line with circle markers curve represents the center of the battery cell, which exhibits the highest temperature, approximately 4 degrees Celsius higher than references 1 and 2. The dot line with square makers and dot line with triangle markers curves represent the surface of the terminal of the battery cell, which has the second highest temperature, around 2 degrees Celsius higher than references 1 and 2. The solid line with circle markers curve represents the bottom of the battery cell, which is only 0.5 degree Celsius higher than references 1 and 2. Lastly, the solid line with square markers and solid line with triangle markers curves represent the surface bottom of the battery cell, which has the lowest temperature and is used as a reference point for the other sensors. This detailed temperature mapping allows for a comprehensive understanding of the thermal behavior of the battery under a 5 C discharge condition.

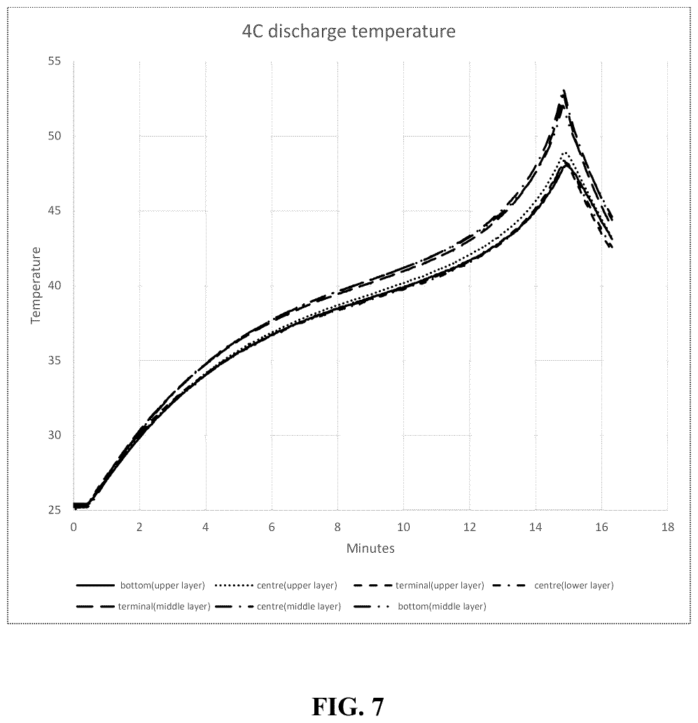

FIG. 7 illustrates the temperature data recorded in 4 C discharge from a 2000 mAh smart battery equipped with high-precision digital internal thermal sensors. The graph displays the internal temperature of a 2000 mAh winding battery during a 4 C discharge. Seven curves are plotted, each representing a different position within the battery. The long dash-dot-short dash curve, indicating the center position of the middle layer, shows the highest temperature, approximately 5 degrees Celsius higher than the other curves. The long dash and long dash-double dot curves represent the terminal and bottom positions respectively in the middle layer, with temperatures around 4 degrees Celsius higher than the other curves. The dot curve corresponds to the center position of the upper layer, which is about 1 degree Celsius higher than the other curves but 3 degrees Celsius lower compared to the middle layer sensors. The solid line and short dash curves represent the bottom and terminal positions respectively in the upper layer. And finally the short dash-dot-short dash curve represents the center position in the lower layer. The curves are all exhibiting similar but not identical temperature characteristics, thus validating the uneven temperatures in different parts of the battery. These findings highlight the importance of precise thermal management in battery design to ensure optimal battery performance, lifespan, and safety.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

1. A rechargeable battery system comprising:
a battery cell having a laminated housing enclosing electrolyte and electrode stacks;
a thermal sensing pad embedded within the battery cell, the thermal sensing pad comprising a plurality of temperature sensors disposed at different internal positions within the battery cell, each temperature sensor encapsulated in an electrolyte-resistant material;
an integrated circuit board electrically coupled with the thermal sensing pad, the integrated circuit board configured to:
(a) receive sensor signals from the temperature sensors;
(b) convert the sensor signals into digital temperature data; and
(c) transmit the digital temperature data to a battery management system;
wherein the battery management system is configured to analyze the digital temperature data to assess internal temperature conditions of the battery cell.

2. The battery system of claim 1, wherein the battery management system is further configured to perform corrective action in response to detecting a thermal condition indicative of thermal runaway or uneven temperatures in different parts of the battery cell.

3. The battery system of claim 1, wherein the thermal sensing pad has a thickness of less than 0.3 mm and is embedded in direct contact with a surface of the electrode stacks or in a middle layer of the electrode stacks.

4. The battery system of claim 1, wherein the temperature sensors comprise at least one of: a thin-film micro-thermocouple, a thin-film resistance thermometer (RTD), or a thermistor.

5. The battery system of claim 1, wherein the integrated circuit board is further configured to analyze trends in temperature data, including detecting temperature rise rates or localized hot spots.

6. The battery system of claim 1, wherein the thermal sensing pad includes at least five temperature sensors positioned respectively near a battery terminal, at a central region, and at a base portion of the battery cell.

7. The battery system of claim 1, further comprising a communication interface selected from the group consisting of USB and Bluetooth for transmitting the temperature data from the integrated circuit board.

8. A method of measuring internal temperature within a battery cell, the method comprising:
embedding a thermal sensing pad within the battery cell, the thermal sensing pad comprising a plurality of temperature sensors at respective positions within the cell;
measuring temperature data from each of the plurality of temperature sensors during battery operation;
transmitting the temperature data to an integrated circuit board;
converting the temperature data into digital signals using the integrated circuit board; and
communicating the digital signals to a battery management system for analysis.

9. The method of claim 8, further comprising analyzing the temperature data to identify a thermal anomaly, and initiating a corrective action to prevent thermal runaway or uneven temperatures in different parts of the battery cell.

10. The method of claim 8, wherein the thermal sensing pad comprises at least five temperature sensors located at spatially distinct regions including a battery terminal, a central portion, and a base of the cell.

11. The method of claim 8, wherein the temperature sensors are selected to provide a thermal measurement accuracy within ±0.2° C. over a range of 20° C. to 50° C.
